(19) United States
(12) Patent Application Publication
(10) Pub. No.: US 2006/0190750 A1
(43) Pub. Date: Aug. 24, 2006

(54) System power management based on motion detection

(75) Inventors: Sergio Maggi, San Mateo, CA (US); Paul McAlpine, Fremont, CA (US); Remy Zimmerman, Belmont, CA (US); Jean-Michel Chardon, Livermore, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Logitech Europe S.A., Romanel-sur-Morges (CH)

(21) Appl. No.: 11/064,884

(22) Filed: Feb. 22, 2005

(51) Int. Cl. G06F 1/32

(52) U.S. Cl. 713/320

(57) ABSTRACT

A power management component in a computer system includes an imaging device operatively connected to a computer. When the computer has entered a low power state, the imaging device can continue to operate to detect motion in its field of view. When “enough” motion is detected, the imaging device can signal the computer in a manner as to transition the computer to a full power state. In another aspect of the present invention, the imaging device can determine that there has been insufficient motion for a predetermined period of time and initiate a transition of the computer to a low power state.

### BACKGROUND OF THE INVENTION

The present invention relates generally to computers, including laptop type computers and desktop type computers, and in particular to power management in computers.

Laptop computers, commonly referred to as notebook computers or simply “notebooks”, have become a popular format for computers. Notebook computers are portable and have processing and storage capacities comparable to desktop systems, and thus constitute a truly viable alternative to desktops. However, a serious shortcoming among notebook computers is the limited power capacity of their batteries. Consequently, power management in notebook computers has become essential to battery life. Power management in desktop systems is also an increasing concern from the point of view of reducing power waste, reducing power bills, and so on.

Power management refers to the different power states of the system, whether it is a notebook computer or a desktop unit. The power states typically refer to the power state of the computer, but may also refer to the power state of its components such as the monitor or display, a hard drive, and so on.

For a notebook computer, managing the power state of the CPU (central processing unit) is important to its battery life. Commonly used power states include the ready state, where the computer is fully powered up and ready for use. A low power state attempts to conserve battery life by reducing power to the system. For example, a suspend state typically refers to a low power state in which power to most of the devices in the computer is removed. A hibernate state is an extreme form of low power state in which the state of the machine (e.g., it's register contents, RAM, I/O caches, and so on) are saved to disk, and then power is removed from the CPU and memory, as well as the devices.

Resumption of the ready power state from a suspend state is typically effected by a keyboard press, or mouse movement. Either action generates a signal that can be detected by wakeup logic, which then generates signals to bring the other components to the active and working state. Waking up from the hibernate state involves performing a boot sequence. When the system is booted, the state information previously stored to the disk is read to restore the system to the state at the time just prior to hibernation.

### BRIEF SUMMARY OF THE INVENTION

As shown by the illustrative embodiments disclosed herein, the present invention relates to a power control method and apparatus for a computer. An image capture device operates to detect the presence of motion in its field of view. The computer normally operates in a full power state. In accordance with one aspect of the present invention, when the computer is idle, it is placed in a low power state; however, the image device continues to operate. When motion is detected by the image capture device, it generates a wake-up signal. The wake-up signal serves to restore the computer to the full power state.

In accordance with another aspect of the invention, if the image capture device determines that there is insufficient motion for a predetermined period of time, it can generate a suspend signal. The suspend signal serves to put the computer in the low power state.

### BRIEF DESCRIPTION OF THE DRAWINGS

Following is a brief description of the drawings that are used to explain specific illustrative embodiments of the present invention:

FIG. 1 shows a generalized block diagram of a computer and an image capture device according to the present invention;

FIG. 1A shows a more specific configuration of the system shown in FIG. 1;

FIG. 1B shows yet another specific configuration of the system shown in FIG. 1;

FIG. 2 shows a generalized block diagram of an image capture device that is configured according to the present invention;

FIG. 3 is a high level flow diagram showing the general actions performed which lead to a transition to the SUSPENDED state;

FIG. 4 is a high level flow diagram showing the general actions performed by an image capture device according to the present invention upon entering the SUSPENDED state;

FIG. 5 is a high level flow diagram showing the general actions performed by an image capture device according to the present invention which lead to a transition to the SUSPENDED state;

FIG. 6A-6H are illustrative images showing results from various stages of motion detection processing as embodied in the present invention; and

FIG. 7 shows a high level block diagram of the image processing used in the present invention embodied in hardware.

### DESCRIPTION OF SPECIFIC EMBODIMENTS

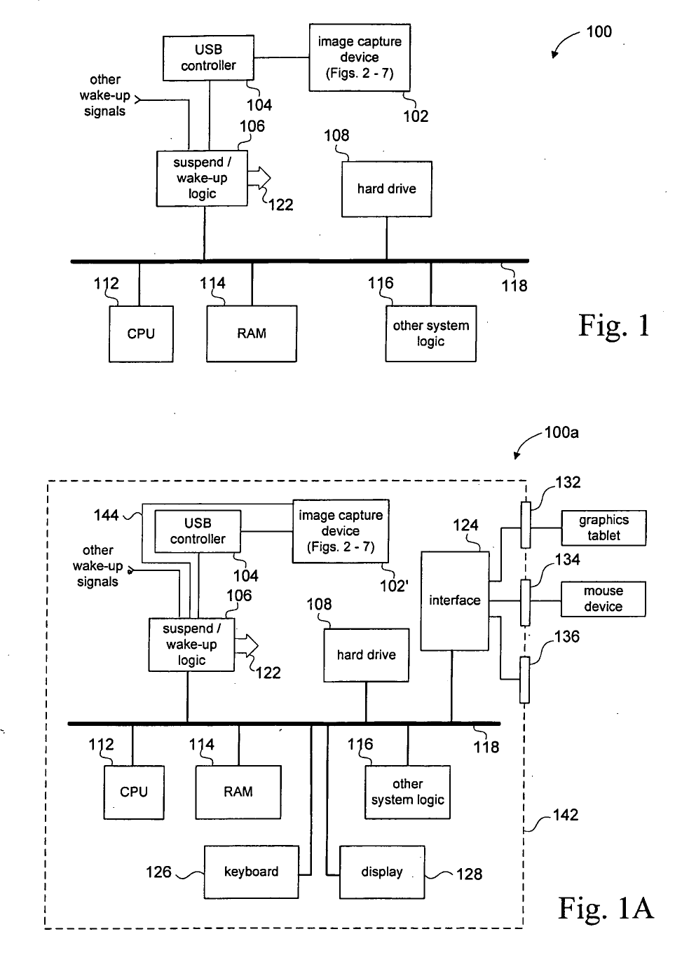

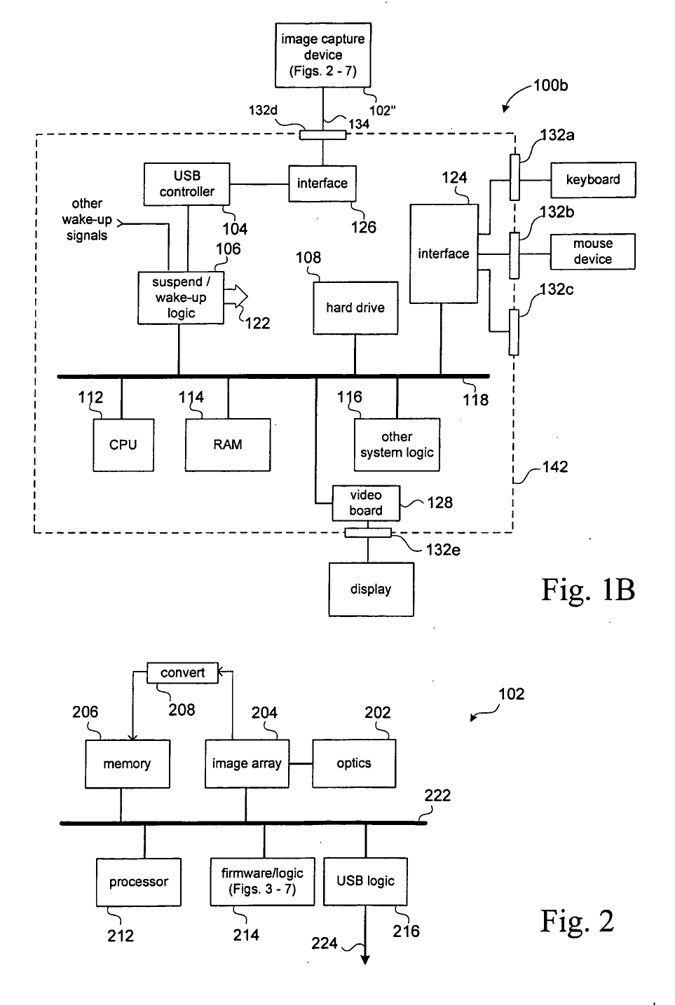

The computer system 100 shown in FIG. 1 illustrates a typical embodiment of the present invention. The computer system can be desktop model, or a laptop, or any other suitable format.

CPU (central processing unit, 112) is a typical data processing component that executes program instructions stored in memory. Random access memory (RAM, 114) is a typical memory component for storing data and program instructions for access by the CPU 112. A hard drive 108 is a typical high capacity storage device for storing data and programs. FIG. 1 shows specific blocks of logic 104, 106 that are pertinent to the discussion of the present invention. The remaining system logic is represented as other system logic 116. The foregoing components typically coordinate their actions and communicate data by asserting control signals on control lines and transmitting data over data buses. Most of these signal and data lines are collectively represented by a system bus 118 shown in FIG. 1.

An image capture device 102 is shown connected to a USB (universal serial bus) controller 104. The image capture device will typically be some form of digital camera, capable of capturing and storing images. The image capture device 102 according to the present invention will be discussed in further detail with respect to the identified figures. As will be explained, the image capture device 102 can be configured as an internal device or an external peripheral.

The USB interface is commonly used in contemporary computer devices, and thus is the interface that was contemplated for the image capture device 102 at the time of the present invention. The USB controller logic 104 operates according to the USB specification. However, it will be appreciated that any other suitable interface logic can be used to practice the present invention.

Logic/firmware is typically provided in the computer to detect when the computer should be transitioned to a low power state, and then to perform a sequence of operations to place the computer into a low power state. For example, a known power management technique is the Advanced Configuration and Power Interface (ACPI), and is used in contemporary Intel®-based personal computers (PCs). ACPI provides a standard for implementing power management in PCs. Of course, it is understood that the present invention can be used with other power management techniques and other hardware platforms.

FIG. 1 shows suspend and wake-up logic 106 which provides at least some of the functionality for performing a suspend sequence to transition the computer from a full power state to a low power state. The logic 106 also includes performing a wake-up sequence to transition the computer from a low power state to the full power state. In the case of an Intel®-based machine, for example, some of the logic 106 may be included in the BIOS (basic IO system). FIG. 1 also shows the logic 106 might include control lines 122 that can be used to send signals to the various components in the computer to enter a low power state or to transition to a full power state.

The wake-up logic 106 may include functionality for determining system inactivity. The measure of “activity”, or a lack of activity, is implementation specific and will vary from one manufacturer to another. Typically, however, activity is based on the number and/or frequency of asserted interrupts, accesses to specific areas in memory, disk activity, and so on. When inactivity is detected for a period of time, the logic 106 can initiate a sequence to place the computer in a low power state.

FIG. 1A shows the present invention as embodied in a more specific illustration of a computer system 100a. The figure shows the image capture device 102′ configured as an “internal” device. For comparison, devices such as a mouse, or a graphics tablet, or a trackball, control devices (e.g., joystick, steering wheel, and so on), are deemed “external” devices because they can be connected to the computer via external ports 132a-132c. The components of a computer are typically contained in an enclosure 142. Within the enclosure are most of the components needed to operate the computer. The enclosure usually includes a number of connectors or ports 132a-132c (commonly referred to as “external connectors” or “external ports”), which traditionally demarcate the boundary between what is inside the enclosure 142 and that which is outside of the enclosure. External devices can be connected to the computer via one these connectors or ports 132a-132c. Interface circuitry 124 provides signal conditioning (drivers) and logic signaling that may be needed to connect the external device to the system bus 118. Typical connectors includes RS-232, SCSI (small computer systems interface), PS-2 ports (in the case of an Intel®-based machine), USB ports, FireWire (IEEE1394), PCMCIA (Personal Computer Memory Card International Association), and so on.

The image capture device 102′ shown in FIG. 1A, therefore, is “internal” in the sense that its connection to the computer is made within an enclosure 142 of the computer, not by way of a connection to one of the connectors 132a-132c. Though FIG. 1A shows a USB interface logic 104, it is understood that any suitable internal interface logic can be used. USB is disclosed for purposes of explaining a particular implementation of the present invention. The configuration shown in FIG. 1A is representative of laptop computers in which a keyboard 126 and a display 128 are typically configured as “internal” components; i.e., their connection to the system bus 118 is made internally, not by way of an external connector. A typical “external” component might be a mouse. In fact, an external keyboard can be connected to a laptop as a substitute for the built-in keyboard.

FIG. 1B shows the present invention embodied in yet another configuration of a computer system 100b. The configuration shown in FIG. 1B is representative of a so-called desktop model computer system. In a desktop format, typical external components include a keyboard and a display. The external keyboard is connected to the computer via the interface 132a; e.g., a PS-2 connection. The external display is likewise connected to the computer via an interface 132e. A video card 128 interfaces the display to the system bus 118.

FIG. 1B further shows the image capture device 102″ to be an external device that is connected to the computer via an external port 132d. A typical format for such devices is the digital camera, which connects to the computer in accordance with the USB standard (though any suitable interface can be used). The interface 132d, in such a case would be an external USB connector. Interface circuitry 126 might be provided to connect the USB device to the USB controller 104.

The connection 134 of the image capture device 102″ to the computer can represent a wireless connection between the image capture device and the computer. Contemporary standards include Bluetooth® (IEEE 802.15). An infrared (IR) connection is also possible. It can be appreciated that the USB controller 104 and the interface 126 would then be replaced with suitably configured circuitry to provide electrical and signaling support for a wireless interface. Similarly, the connection 134 can be a wired standard other than USB; e.g., firewire.

Referring now to FIG. 2, a generalized block diagram of an image capture device (e.g., 102 in FIG. 1) according to the present invention is shown. An optics section 202 provides the light gathering function. The optics typically includes one or more lens elements, but may simply be an opening in an enclosure that lets light into the device.

In the case of a laptop computer having an internal image capture device such as shown in FIG. 1A, the optic section 202 might be mounted close to the keyboard facing the user. This allows for imaging a person who is in proximity to the keyboard. The optics section 202 can be arranged along the periphery of the display/lid of the laptop, which would provide a view of the surrounding area of the laptop.

The optics section 202 images the light gathered in its field of view onto an image capture element (or array) 204. The image capture element 204 can be a charged-coupled device (CCD) or a CMOS-based device. Of course other image acquisition technologies can be used.

A memory 206 is typically connected to the image capture element 204 so that an image that has been acquired by the image capture element can be converted and stored to memory. The conversion typically involves conversion circuitry 208 which reads out the content of the image capture element 204 and converts the information to a suitable format for processing by the processor 212. The memory 206 can be configured to store some number of images for subsequent processing.

As will be discussed below, in accordance with one embodiment of the present invention, the firmware/logic 214 will comprise a hardware implementation of the algorithms used to perform image processing operations for detecting motion. In this embodiment, the firmware/logic 214 is integrated in an ASIC-based (application specific integrated circuit) implementation which performs the image processing. Alternative hardware implementations (i.e. SoC, system on chip) integrate blocks of FIG. 2 in a different physical component, without modifications to the conceptual functional block diagram.

In accordance with another embodiment of the present invention, the processor 212 performs processing of images stored in the memory 206 according to a method embodied in the firmware/logic 214. In this embodiment, the firmware/logic 214 may comprise primarily program instructions burned into a ROM (read-only memory). The images stored in the memory 206 would be fed to the processor 212 as a video stream and processed by executing instructions stored in the firmware/logic 214.

USB logic is provided to interface the image capture device 102 in a suitable manner to the computer, as discussed above in connection with FIGS. 1A and 1B. A connector 224 is provided to make the connection to the computer. A bus structure 222 serves to connect the various elements together.

As noted above, the connection of the image capture device 102 to the computer can be made wirelessly. Contemporary standards include Bluetooth® (IEEE 802.15). An infrared (IR) connection is also possible. In such cases, it is understood that the “connector” 224 shown in FIG. 2 will be suitably configured element that conforms to the wireless technology and standard being used; e.g., an antenna (wireless), or an IR transmitter.

Operation of the present invention as embodied in the systems shown in FIGS. 1 and 2 will now be discussed. For purposes of the discussion, an Intel®-based machine will be assumed and the ACPI method will serve as the power management model.

A computer typically exists in one of the following power states: READY, SUSPENDED, and HIBERNATE. In the READY state, the computer is fully powered up and ready for use. Typically there is no distinction between whether the computer is active or idle, only that the computer is fully powered.

The SUSPENDED state is a power state which is generally considered to be the lowest level of power consumption available that still preserves operational data; e.g., register contents, status registers, paging register, and so on. The SUSPENDED state can be initiated by either the system BIOS or by higher-level software above the BIOS. The system BIOS may place the computer into the SUSPENDED state without notification if it detects a situation which requires an immediate response such as in a laptop when the battery charge level falls to a critically low power level. When the computer is in the SUSPENDED state, the CPU cannot execute instructions since power is not provided to all parts of the computer.

Some computers implement a HIBERNATE state in which the data state of the computer is saved to disk and then power to the computer is removed; i.e., the computer is turned off. When power is restored, the computer performs the normal boot sequence. After booting, the computer remembers (e.g., by way of a file) that it was HIBERNATE'd and reads the stored state from the disk. This effectively restores the machine to its operating state just before the time the HIBERNATE was initiated.

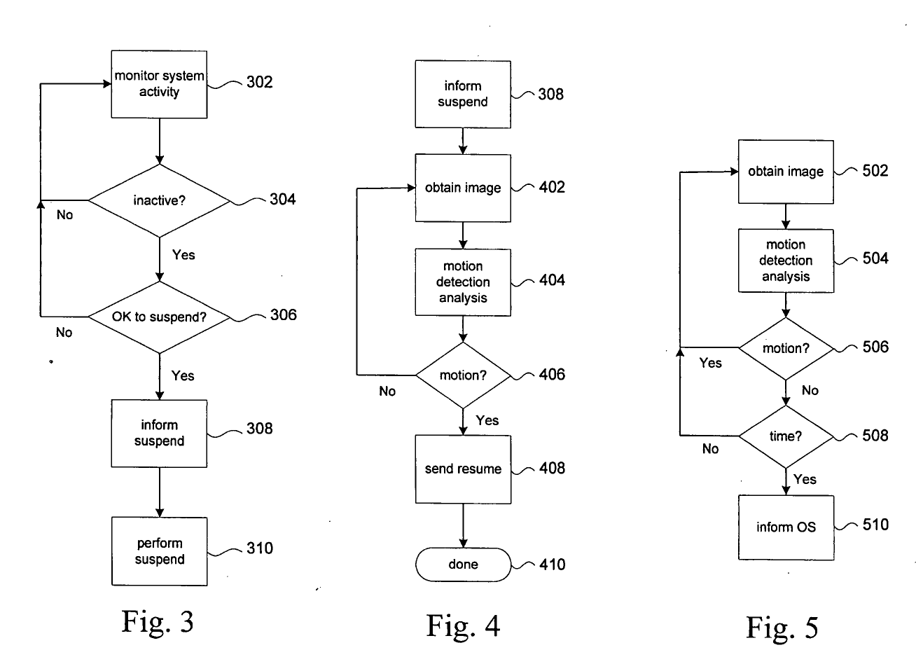

Referring to FIG. 3, a high-level discussion of the sequence of events leading to the SUSPENDED state will be discussed. Logic and/or firmware are provided to monitor the activity of the system, step 302. The specific activity that is monitored will vary from one implementation to the next. As mentioned above, the measure of activity can be based on number and/or frequency of asserted interrupts, accesses to specific areas in memory, disk activity, and so on.

If a determination is made (step 304) that the system has been inactive, then an attempt will be made to enter the low power SUSPENDED state. This is typically achieved by logic that monitors the activity and signals the OS (operating system). In a step 306, the OS makes a determination whether it is OK to transition to the SUSPENDED state. This typically involves the OS signaling the device drivers and applications to ask if it is OK to suspend. If a driver or application rejects the suspend request, then the system resumes monitoring the system activity, step 302.

If it is determined that it is OK to suspend, then the OS signals the drivers and applications in a step 308 that a suspend is going to occur. The drivers and applications can then take action to save their state, if necessary. When the OS determines that the drivers and applications have taken steps to save their state (e.g., receiving a positive indication, or simply assumes that the state has been saved), then the OS will initiate a suspend sequence, in a step 310. This may involve invoking some functionality in the BIOS to sequence the machine to the SUSPENDED state.

Referring to FIG. 4, a discussion of operation of the image capture device 102 according to the present invention will be made. For discussion purposes, it can be assumed that the image capture device 102 is configured with a USB interface. Thus, when the OS performs an inform suspend operation (step 308, FIG. 3), the OS will issue an appropriate USB suspend signal to any USB devices connected to it including the image capture device 102. Upon receiving the suspend signal, the image capture device 102 will begin operating according to the flowchart outlined in FIG. 4.

In a step 402, the image capture device 102 captures an image (image acquisition) and saves it to its memory 206. In a step 404, a motion detection process is performed by suitable analysis of the stored images. It can be appreciated that the memory 206 must be initially “primed” with enough images so that the action step 404 can be performed; e.g., typically, the most recently captured (acquired) image is compared with the previously captured image. If, in a step 406, it is determined that there is no motion, then processing proceeds to step 402 where another image is captured. Though not shown in the figure, it can be appreciated that this process can be interrupted and stopped when the system resumes full power mode. Also, a suitable time delay between image captures can be provided, either as a hardcoded value or more typically as a user configurable parameter.

If, in step 406, it is determined that motion has been detected, then the image capture device 102 will generate (step 408) a suitable signal that can be detected by the computer. In the situation where the image capture device 102 is an internal device as illustrated in FIG. 1A, the signal can be communicated to the wake-up logic 106 via a control line 144 shown in FIG. 1A. Alternatively, the internal image capture device 102 can be configured to generate an interrupt signal at step 408. The OS can be configured with a suitable interrupt handler to handle the interrupt that is generated.

In the case of a USB-compliant image capture device, step 408 may be an operation where the imaging device issues a USB Remote Wake-up command to the USB controller 104. The USB controller 104 can then respond to the command accordingly to resume from the SUSPENDED state. The USB controller resumes USB traffic. All the devices on the bus leave the SUSPENDED state. The USB tree is now functional and the OS informs the application of the device responsible for the wake-up. After which every application responds according to its internal design.

In the case of SUSPENDED, the device requires a 500 μA power source. For an internal device, this can be easily provided by the manufacturer of the motherboard. However, in the case of an external USB device, it is usual to cut off power to external devices in the SUSPENDED state, so it typically is not possible for the external device to issue a USB Remote Wake-up command to the USB controller. However, where an external USB-compliant image capture device is employed in a notebook design which provides some minimum power to certain external devices in the SUSPENDED state, the image capture device can operate according to the steps shown in FIG. 4.

In the case of the HIBERNATE power state, a computer having an internal image capture device (102′, FIG. 1) can be configured such that some power is nonetheless provided to the device even in the HIBERNATE state. Furthermore, the computer can be configured with a software controlled switch that can turn on power to the computer, and thus appear to the computer that a user had toggled the power switch.

Referring to FIG. 5, operation of the image capture device in accordance with another aspect of the present invention will now be discussed. Here, the image capture device 102 can be used to transition the computer from the full power state to the low power SUSPENDED state. Thus, in a step 502, an image is captured and stored in memory 206. In a step 504, two or more images stored in the memory 206 are analyzed to determine the presence of motion. If in a step 506 it is determined that there is motion, then processing continues with step 502 to capture another image. If in step 506 it is determined that there is no motion, then a determination is made in a step 508 whether there has been an absence of motion for some predetermined period of time, such as a hard coded value or a user configured value.

If motion is detected within the predetermined period of time, then processing continues to step 502 to capture the next image. If, on the other hand, there has been no motion for a sufficient amount of time, then processing proceeds according to the flow shown in FIG. 3. For example, the image capture device 102 can be configured to signal the OS to initiate the suspend process outlined in FIG. 3. In the case of an image capture device that is configured as an internal device, a suitable interrupt configuration can be provided; the OS can be signaled by an interrupt that is generated by the image capture device. The OS in response would then proceed according to FIG. 3, beginning at decision step 306. For example, the internal image capture device can be configured with two interrupts, one for placing the computer in the SUSPENDED state and another interrupt for placing the computer in the HIBERNATE state.

As an alternative to using multiple interrupts, the image capture device can be configured to be associated with a memory address that maps to an interrupt register that is accessible by the device. The image capture device firmware/logic can then load a suitable value in the interrupt register to indicate the power state to which the computer should transition. Thus, it is possible to transition to low power configurations other than SUSPEND and HIBERNATE. For example, the interrupt handler can simply reduce the clock speed of the CPU. The LCD display can be turned off, or its brightness can be adjusted to a predetermined brightness level or a level based on detected ambient light levels. The hard disk can be slowed or stopped. These transitions can be configured via a suitable user interface.

In the case of a USB-compliant image capture device that is configured to be an external device, the imaging device can cause a USB SUSPEND or a HIBERNATION transition via the application software.

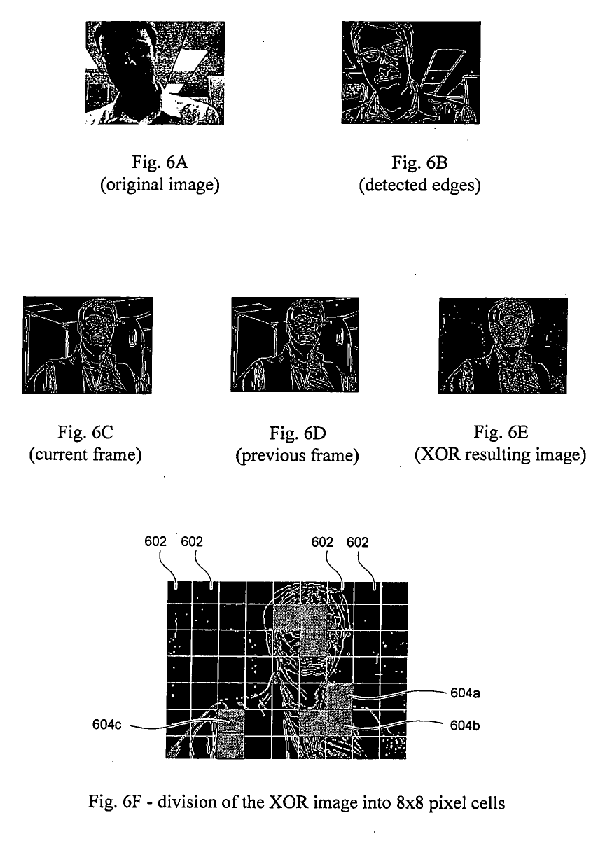

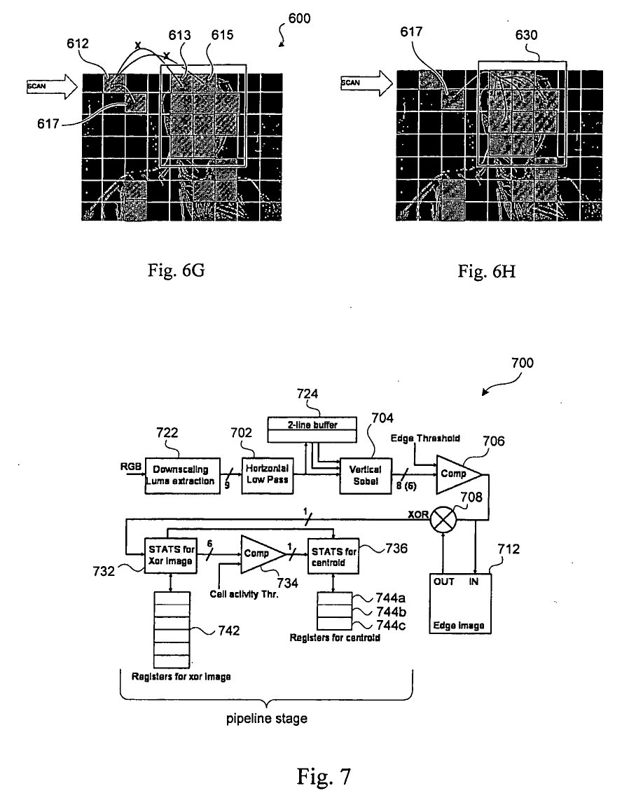

Referring to FIGS. 6A-6H, motion detection processing as embodied in the present invention will now be discussed. The particular motion detection algorithm that is used in the present invention is one of a number of known motion detection algorithms. It can be appreciated therefore that other motion detection algorithms may be suitable for the present invention.

The algorithm incorporated in the present invention is based on edge detection. The motion detection algorithm (MDA) software solution comprises the following process:
Edge detection of the current frame
Difference between current and previous edge detection using a XOR operator
Detection of regions affected by motion
Detection of the region of interest (ROI)
   A current implementation of the present invention contemplates using the above algorithmic solution. It is understood, however, that any suitable motion detection algorithm can be used.
   Edge Detection

Images (frames) that are stored in the image capture device 102 are scaled down in size and input to the algorithm; e.g., an image size of 80×60 pixels can be used. Edge detection is performed using the Canny edge detection technique, where three main operations are performed:
(A) Low pass filtering of the image using a Gaussian 5×5 kernel;
(B) Gradient extraction using a horizontal and vertical Sobel filter; and
(C) No-maximum removal.

The low pass filter removes noise inherently present in the image acquisition process, especially in low-light conditions. The gradient of the low-passed image is computed by convolving it with the Sobel operator (Eq. 1):

$$[ \begin{matrix}1 & 0 & - 1 \\ 2 & 0 & - 2 \\ 1 & 0 & - 1\end{matrix} ] \qquad ( Eq . 1 )$$

This operation is performed both vertically and horizontally, thus enhancing vertical and horizontal derivatives respectively, whose absolute values are summed up to obtain a final gradient image. The no-maximum removal operation is a technique that facilitates locating the edges in the gradient image. An example of the result of a Canny edge detection action is shown in FIGS. 6A and 6B. FIG. 6A is an example of a captured (acquired) image. FIG. 6B shows the resulting edge-detected image.
Difference Processing

The current and previous edge images are then compared using an XOR operator. The comparison produces near-zero results where edges have not moved, and a positive result that indicates the locations where edges do not overlay, meaning that motion has taken place. An example of the result obtained by such an operator is shown in FIGS. 6C-6E. FIG. 6C shows a current edge-detected frame, while FIG. 6D shows an edge-detected image of a previous frame. FIG. 6E shows the result of an XOR operation between the current and previous frames. It can be seen that the XOR operator has reduced the detection of the part of the scene that did not move and exalted the moving parts (e.g., the subject's head and body).

Detection of Active Regions

The XOR image is used to detect which parts of the scene are moving. As shown in FIG. 6F, the image is divided into cells 602 whose size can be chosen at will. FIG. 6F, for example, shows 8×8 pixels. In each cell the number of active pixels is counted. A pixel is defined as “active” if its value is greater than zero. If the number of active pixels in the cell is bigger than a certain threshold, then the cell itself is said to be active. These operations are described pictorially in FIG. 6F. Thus, for example, cells 604a-604c are active cells. The binary image obtained contains the information about the active cells and is thus called an “active-cell image.”

Detection of ROI

The detection of the active cells is the main result of the motion detection algorithm. Once this information is available, different things can be done, according to different goals. In the software implementation of the entire MDA, the aim that was considered was to establish an area of the image that is most likely to contain the head of the subject (based on the amount and the structure of motion) in a typical webcam use scenario.

In this case, it is fundamental that the scenario is well defined, as well as the main goal of the algorithm, since it is in this part that heuristics and smart hypothesis play an important role to obtain the desired result. To accomplish this task, the algorithm acts as depicted in FIGS. 6G and 6H.

With respect to FIG. 6G, an active-cell image is scanned beginning at the top left corner, from left to right, and progressing downward in raster fashion. If an active cell is encountered (e.g., active cell 612), then its position is compared to that of the other active cells (e.g., 613, 615, 617). If a different cell is “too far” from the actual one, then nothing happens and the scan continues to the next cell. By “too far” is meant that the distance between the two cells exceeds some predetermined threshold.

FIG. 6G shows two examples of pairs of active cells that are “too far” apart. The active cell 612 is the first cell that is encountered in the scan. The cell 613 is next encountered. The cell 612 as compared to the active cell 613 is deemed “too far”, as indicated by the letter X in the figure. No action is taken and scanning continues. The next encountered active cell is cell 615, which also is deemed “too far” from the active cell 612. Consequently, no action is taken and scanning continues.

As scanning continues, active cell 617 is encountered. Compared to active cell 612, cell 617 is deemed not too far from cell 612. This causes a counter to be incremented, and the event is called a “hit”. As can be seen in FIG. 6G, only one hit occurs since all the remaining active cells are deemed “too far”.

Continuing with the algorithm, refer now to FIG. 6H. A second scan is performed, which takes the second active cell 617 as the reference cell for comparison. In this case, many other close active cells are found; this gives origin to multiple hits, indicated by the black arrows. When the number of hits reaches a certain threshold, then the process stops and the average position of the neighboring active cells is taken as the coordinate of the rectangle. The threshold can be related to an estimate of the head dimension indicated by the rectangle 630, for example. These average coordinates constitute an estimate of the position of the subject's head.

The foregoing discussion described how spatial information is taken into account to estimate the subject's head position. The complete software MDA also uses temporal information. Thus, by comparing the position of the head estimated in the current frame to the one found for the previous frame. If the two positions are too far apart, then the new position is ignored, and the head position is maintained at the previous coordinates.

Next, with reference to FIG. 7, is a discussion of an adaptation of the foregoing described software-based algorithm in a more hardware-based implementation such as in an ASIC or a SoC. This hardware solution includes the following:
a. Horizontal low-pass filtering of the input image;
b. Vertical differentiation by Sobel operator and thresholding;
c. XOR image difference;
d. Motion statistic gathering.

An acquired image is fed into a downscaler 722 to produce a down-scaled (or down-sampled) version of the image from the video stream; in a particular implementation, its dimensions are 80×60 pixels. This downscaled image serves as an input to the algorithm. In part (a), each line of the image is low-pass filtered by a low-pass filter stage 702 using a single-line horizontal mask. In a particular embodiment, the low-pass filter 702 is a simple mean filter, i.e., a filter that computes the mean value of adjacent pixels. This differs from the software solution, where a 5×5 Gaussian low-pass filter was used. By processing only one line at a time, line-memory need is minimized.

In part (b), the data stream is fed into a Sobel operator stage 704 to find the edges of the image, as in the software approach. In the hardware adaptation, however, we just consider the result of the convolution between the low-pass filtered image obtained in the previous step and the vertical Sobel mask of Eq. 1. To perform this operation, three lines of the image are necessary. A two-line buffer 724 provides the 2×3 pixels from the previous two lines, while the remaining 1×3 pixels of the current (third) line are provided “on-the-fly” from the low-pass filter stage 702. In this step, we obtain information only on the vertical edges. This is deemed to be sufficient, as it has been observed that the vertical edges contain most of the information needed to detect interesting motion.

Once the vertical edges are detected, a global edge threshold is applied to the image in order to obtain a binary image. This operation is performed by a comparator stage 706 and corresponds to the no-minimal removal that is performed in the Canny edge detector of the software approach, but is much simpler and thus is less accurate. Nonetheless, it was discovered to produce good results for our overall goal.

The result of the foregoing stages is that of obtaining an edge mask image (vertical edges in this case). In part (c), this image is compared to the previous one that is stored in an edge image memory 712 by an XOR operator stage 708 which corresponds to the XOR operation in the software solution. This comparison is performed in pixel by pixel fashion, feeding the pipeline stage.

At this point, the hardware solution has at its disposal the information of the XOR image. This image will be certainly different from the XOR image obtained by the software solution, since a different process was used to obtain the images for performing the XOR operation. However, once produced and stored in memory, the XOR result can be used directly by the software solution in a transparent way to compute the active-cell image. In the hardware solution, however, we have some constraints about memory and thus it is not practical to store this image. Consequently, the active-cell image is computed on the fly, as the XOR values enter the pipeline stage.

To do this, a certain number of N-bit registers 742 is used to count the number of active pixels within a line. Each register will store the number of active pixels within N consecutive pixels. Since in this implementation we set the dimension of the cell to 8×8 pixels—as in the software case—we use ten eight-bit registers to store the information of a line, which is 80 pixels wide.

When eight lines are processed, the information contained in the registers is the number of active pixels in an 8×8 block, i.e., the same information we had in the software implementation. This information is thresholded via a comparator 734 and each cell is then deemed to be active or inactive based on the programmable cell activity threshold. Control logic 732 for the N-bit registers 742 sets the registers to zero in preparation for processing the next eight lines.

At the end of this process, we obtain an active-cell image, which can be stored in memory and used again by the software solution. As done for the XOR image, we process this image on the fly. Hardware implementation cannot perform the same algorithm used in software to detect the presence of the head in an efficient way, since comparisons and the multiple scan that should be performed do not fit a hardware solution efficiently.

For this reason, we have chosen to just compute a motion centroid, i.e. the average x and y coordinates of the active-cells, since this can be done as active cells are detected. To do this, we used two supplementary registers 744a, 744b to accumulate the positions of the detected active cells. A centroid computation stage 736 performs the operations to determine the centroid. Once the entire image is scanned, these registers will contain the sum of the x and y coordinates of the active cells. Using an additional counter 744c that counts the number of the active cells, a simple division performed by the computation stage 736 produces the coordinate of the centroid.

What is claimed is:

1. A method for controlling power in a computer comprising a data processing unit, a memory, system logic, and a system bus to which the processing unit, the memory, and the system logic are connected, the computer being in a low power state, the method comprising:
capturing one or more images in a digital camera, the digital camera including a camera memory in which the images are stored;
detecting a presence of motion from among the images stored in the camera memory; and
if motion is detected among the images, then sending a first signal to the system logic that will cause the computer to operate in a full power state.

2. The method of claim 1 wherein the first signal is a USB (Universal Serial Bus) Remote Wake-up Request signal.

3. The method of claim 1 wherein the digital camera is an internal device that is connected to the system bus.

4. The method of claim 1 wherein the computer includes at least one external port and interface logic that connects the external port to the system bus, the digital camera being connected to the external port.

5. The method of claim 1 further comprising:
capturing one or more second images in the digital camera;
determining from the second images whether there has been an absence of motion for a predetermined amount of time; and
if there has been an absence of motion for a predetermined amount of time, then sending a second signal to the system logic that will cause the computer to transition to the low power state.

6. A computer having a power control capability comprising:
a central processing unit (CPU);
a memory;
a system bus to which the CPU and the memory are connected, whereby the memory can be accessed by the CPU when the CPU executes program instructions;
first system logic operative to selectively put the computer into a full power operating state or a low power state;
an image capture component; and
second system logic in communication with the image capture component and connected to the system bus, the second system logic operative to initiate a wake-up sequence to put the computer into the full power state in response to receiving a first signal from the image capture component,
the image capture component comprising a processing component, an image memory, and a connection to the system bus,
the image memory being operable to store plural images;
the processing component being operative to:
perform motion detection on images stored in the image memory; and
if motion is detected among the images, then generate the first signal so that it can be transmitted to the second system logic.

7. The computer of claim 6 further comprising an internal USB port to which the image capture device is connected.

8. The computer of claim 7 wherein the first signal is a USB Remote Wake-up Request signal.

9. The computer of claim 6 wherein the processing component is a system on chip (SoC) device.

10. The computer of claim 6 wherein the image capture component includes an ASIC (application specific integrated circuit) which performs a portion of the motion detection.

11. The computer of claim 6 wherein the image capture device further comprises firmware, wherein the processing component is a data processing unit that is operable to execute instructions contained in the firmware.

12. The computer of claim 6 further comprising one or more external ports, each external port having corresponding interface logic that connects the external port to the system bus, wherein the image capture component is a digital camera connected to a first external port, wherein the connection to the system bus comprises interface logic corresponding to the first external port.

13. The computer of claim 12 wherein the first external port is a USB port.

14. The computer of claim 13 wherein the first signal is a USB Remote Wake-up Request signal.

15. The computer of claim 12 wherein the first external port is a wireless port, and digital camera is wirelessly connected to the first external port.

16. The computer of claim 12 wherein the first external port is an IR (infrared) port, and digital camera is connected to the first external port via an IR connection.

17. The computer of claim 12 wherein the first external port is a firewire port, and digital camera is connected to the first external port via a firewire connection.

18. The computer of claim 6 wherein the processing component is further operative to:
determine the absence of motion among on images stored in the image memory; and
if the absence of motion persists for a predetermined period of time, then generate a second signal so that it can be transmitted to the first system logic,
the first system logic further operable put the computer in the low power state, in response to receiving the second signal.

19. A method for controlling power in a computer comprising:
monitoring activity level in the computer;
transitioning a power level of the computer from a full power state to a low power state; and
subsequent to the transitioning, operating an image capture device to:
capture a plurality of images;
analyze some of the images to detect motion among the images; and
if motion is detected among some of the images, then transition the power level of the computer to the full power state by sending a signal from the image capture device to the computer.

20. The method of claim 19 wherein the image capture device is an internal device.

21. The method of claim 19 wherein the image capture device is an internal device having a USB connection to a system bus.

22. The method of claim 19 wherein the signal is a USB Remote Wake-up signal.

23. The method of claim 19 wherein the image capture device is an external device having a connection to the computer via an external port.

24. The method of claim 23 wherein the connection is one of a USB connection, a Bluetooth®-based connection, or an infra-red connection.

25. The method of claim 19 wherein monitoring activity level includes operating the image capture device to:
capture a plurality of second images;
analyze some of the second images to detect motion among the second images; and
if lack of motion is determined, then send a second signal to the computer to transition the power level of the computer to the low power state.
